(19) United States
(12) Patent Application Publication
(10) Pub. No.: US 2024/0256887 A1
(43) Pub. Date: Aug. 1, 2024

(54) METHOD AND APPARATUS FOR TRAINING NEURAL NETWORK FOR IMITATING DEMONSTRATOR'S BEHAVIOR

(71) Applicants: Robert Bosch GmbH, Stuttgart (DE); TSINGHUA UNIVERSITY, Beijing (CN)

(72) Inventors: Mingxuan Jing, Beijing (CN); Fuchun Sun, Beijing (CN); Lei Li, Beijing (CN); Wenbing Huang, Beijing (CN); Xiaojian Ma, Beijing (CN); Ze Cheng, Shanghai (CN)

(21) Appl. No.: 18/565,312

(22) PCT Filed: May 31, 2021
(86) PCT No.: PCT/CN2021/097252

§ 371 Date: Nov. 29, 2023

(51) Int. Cl. G06N 3/092

(52) U.S. Cl. CPC G06N 3/092

(57) ABSTRACT

A method for training a Neural Network (NN) model for imitating demonstrator's behavior. The method includes: obtaining demonstration data representing the demonstrator's behavior for performing a task, the demonstration data includes state data, action data and option data, wherein the state data correspond to a condition for performing the task, the option data correspond to subtasks of the task, and the action data correspond to the demonstrator's actions performed for the task; sampling learner data representing the NN model's behavior for performing the task based on a current learned policy; and updating the policy by using a generative adversarial imitation learning (GAIL) process based on the demonstration data and the learner data.

### FIELD

Aspects of the present disclosure relate generally to artificial intelligence (AI), and more particularly, to training a Neural Network (NN) model for imitating demonstrator's behavior.

### BACKGROUND

Imitation learning (IL) has been used in many real-world applications, such as automatically playing computer games, automatically playing chess, intelligent self-driving assistance, intelligent robotic locomotion, and so on. It's still a challenge to learn skills for a learner or agent implemented by a neural network model from long-horizon unannotated demonstrations.

There are mainly two kinds of imitation learning methods, Behavioral cloning (BC) and Inverse reinforcement learning (IRL). Behavioral cloning, while appealingly simple, only tends to succeed with large amounts of data a, due to compounding error. Inverse reinforcement learning learns a cost function that prioritizes entire trajectories over others, so compounding error, a problem for methods that fit single-time step decisions, is not an issue. Accordingly, IRL has succeeded in a wide range of problem, but many IRL algorithms are extremely expensive to run on computing resources. As an implementation of IRL, Generative adversarial imitation learning (GAIL) is an imitation learning method that directly learn policy based on expert data without learning the reward function, thus greatly reducing the amount of calculation.

Although GAIL exhibits decent performance, an improvement in the structure and performance for imitation learning would be desirable.

### SUMMARY

The disclosure proposes a novel and enhanced hierarchical imitation learning framework, Option-GAIL, which is efficient, robust and effective in training a neural network model for imitating demonstrator's behavior in various practical applications such as self-driving assistance, robotic locomotion, AI computer games and the so on. The neural network model being trained for imitating demonstrator's behavior may be referred to as agent, learner, imitator or the like.

According to an embodiment, there provides a method for training a Neural Network (NN) model for imitating demonstrator's behavior, comprising: obtaining demonstration data representing the demonstrator's behavior for performing a task, the demonstration data includes state data, action data and option data, wherein the state data correspond to a condition for performing the task, the option data correspond to subtasks of the task, and the action data correspond to the demonstrator's actions performed for the task; sampling learner data representing the NN model's behavior for performing the task based on a current learned policy, the learner data includes state data, action data and option data, wherein the state data correspond to a condition for performing the task, the option data correspond to subtasks of the task, and the action data correspond to the NN model's actions performed for the task, the policy consists of a high level policy part for determining a current option and a low level policy part for determining a current action; and updating the policy by using a generative adversarial imitation learning (GAIL) process based on the demonstration data and the learner data.

According to an embodiment, there provides a method for A method for training a Neural Network (NN) model for self-driving assistance, comprising: training the NN model for self-driving assistance using the method as mentioned above as well as using the method according to aspects of the disclosure, wherein the demonstration data represents a driver's behavior for driving a vehicle.

According to an embodiment, there provides a method for training a Neural Network (NN) model for controlling robot locomotion, comprising: training the NN model for controlling robot locomotion using the method as mentioned above as well as using the method according to aspects of the disclosure, wherein the demonstration data represents a demonstrator's locomotion for performing a task.

According to an embodiment, there provides a method for controlling a machine with a trained Neural Network (NN) model, comprising: collecting environment data related to performing a task by the machine; obtaining state data and option data for the current time instant based at least in part on the environment data; inferring action data for the current time instant based on the state data and the option data for the current time instant with the trained NN model; and controlling action of the machine based on the action data for the current time.

According to an embodiment, there provides a vehicle capable of self-driving assistance, comprising: sensors configured for collecting at least a part of environment data related to performing self-driving assistance by the vehicle; one or more processors; and one or more storage devices storing computer-executable instructions that, when executed, cause the one or more processors to perform the operations of the method as mentioned above as well as to perform the operations of the method according to aspects of the disclosure.

According to an embodiment, there provides a robot capable of automatic locomotion, comprising: sensors configured for collecting at least a part of environment data related to performing automatic locomotion by the robot; one or more processors; and one or more storage devices storing computer-executable instructions that, when executed, cause the one or more processors to perform the operations of the method as mentioned above as well as to perform the operations of the method according to aspects of the disclosure.

According to an embodiment, there provides a computer system, which comprises one or more processors and one or more storage devices storing computer-executable instructions that, when executed, cause the one or more processors to perform the operations of the method as mentioned above as well as to perform the operations of the method according to aspects of the disclosure.

According to an embodiment, there provides one or more computer readable storage media storing computer-executable instructions that, when executed, cause one or more processors to perform the operations of the method as mentioned above as well as to perform the operations of the method according to aspects of the disclosure.

According to an embodiment, there provides a computer program product comprising computer-executable instructions that, when executed, cause one or more processors to perform the operations of the method as mentioned above as well as to perform the operations of the method according to aspects of the disclosure.

By using the hierarchical option-GAIL training method, the training efficiency, robustness and effectiveness as well as the inference accuracy of the trained NN model are improved. Other advantages and enhancements are explained in the description hereafter.

### BRIEF DESCRIPTION OF THE DRA WINGS

The disclosed aspects will hereinafter be described in connection with the appended drawings that are provided to illustrate and not to limit the disclosed aspects.

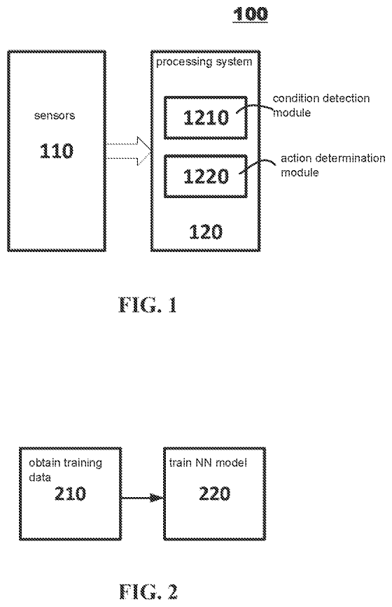

FIG. 1 illustrates an exemplary apparatus according to an embodiment.

FIG. 2 illustrates an exemplary training process according to an embodiment.

FIG. 3 illustrates an exemplary probabilistic graph of one-step option model according to an embodiment.

FIG. 4 illustrates an exemplary relationship between Equation 3 and Equation 5 according to an embodiment.

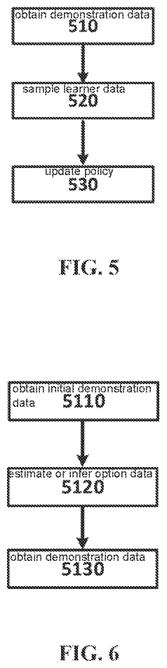

FIG. 5 illustrates an exemplary process for training a NN model according to an embodiment.

FIG. 6 illustrates an exemplary process for obtaining demonstration data according to an embodiment.

FIG. 7 illustrates an exemplary process for updating a policy according to an embodiment.

FIG. 8 illustrates an exemplary process for controlling a machine with a trained NN model according to an embodiment.

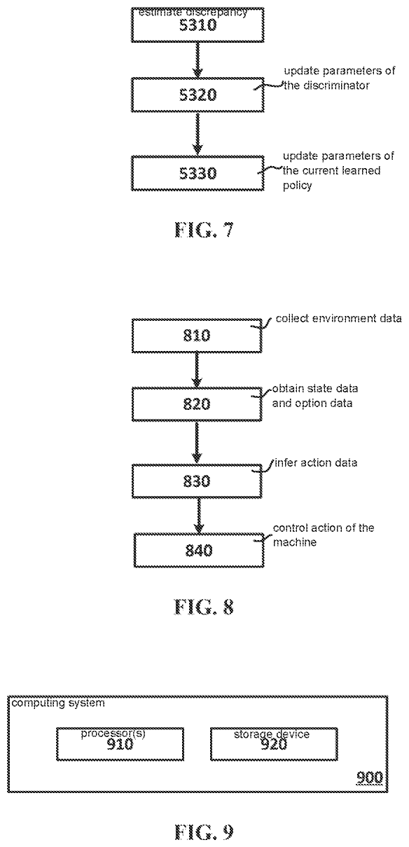

FIG. 9 illustrates an exemplary computing system according to an embodiment.

### DETAILED DESCRIPTION

The present disclosure will now be discussed with reference to several example implementations. It is to be understood that these implementations are discussed only for enabling those skilled in the art to better understand and thus implement the embodiments of the present disclosure, rather than suggesting any limitations on the scope of the present disclosure.

Various embodiments will be described in detail with reference to the accompanying drawings. Wherever possible, the same reference numbers will be used throughout the drawings to refer to the same or like parts. References made to particular examples and embodiments are for illustrative purposes, and are not intended to limit the scope of the disclosure.

FIG. 1 is a block diagram illustrating an exemplary apparatus according to aspects of the disclosure.

The apparatus 100 illustrated in FIG. 1 may be a vehicle such as autonomous vehicle, a self-controlled machine such as robot, or may be a part of the vehicle, the robot, or the like. The autonomous vehicle is taken as an example of the apparatus in FIG. 1 in the following description.

The vehicle 100 can be equipped with various sensors 110 for sensing the condition in which the vehicle is running. The term condition may also be referred to as circumstance, state, context and so on. In the illustrated example of FIG. 1, the various sensors 110 may include a camera system, a LiDAR system, a radar system, sonar, ultrasonic sensors, proximity sensors, infrared sensors, wheel speed sensors, rain sensors and so on. It is appreciated that the set of sensors 110 of the vehicle 100 may include other types of sensors, and may not include all the exampled sensors, any combinations of example sensors are possible to be equipped on the apparatus 100.

The apparatus 100 may include a processing system 120. The processing system 120 may be implemented in various ways, for example, the processing system 120 may include one or more processors and/or controllers as well as one or more memories, the processors and/or controllers may execute software to perform various operations or functions, such as operations or functions according to various aspect of the disclosure.

The processing system 120 may receive sensor data from the sensors 110, and perform various operations by analyzing the sensor data. In the example of FIG. 1. the processing system 120 may include a condition detection module 1210, an action determination module 1220. It is appreciated that the modules 1210-1220 may be implemented in various ways, for example, may be implemented as software modules or functions which are executable by processors and/or controllers.

The condition detection module 1210 may be configured to determine conditions relating to the operation of the car.

The condition relating to the operation of the car may include weather, absolute speed of the car, relative speed to preceding car, distance from preceding car, distance from nearby cars, azimuth angle relative to nearby cars, existence or not of obstacle, distance to obstacle, and so on. It is appreciated that the condition may include other types of data such as the navigation data from a navigation system, and may not include all the exampled data. And some of the condition data may be directly obtained by the sensor module 110 and provided to the processing module 120.

The action determination module 1220 determines the action to be performed by the car according to the condition data or state data from the condition detection module 1210. The action determination module 1220 may be implemented with a trained NN model, which can imitate a human driver's behavior for driving a car. For example, the action determination module 1220 can obtain the state data such as the above exampled condition data for the current time step and infer the action to be performed for the current time step based on the obtained state data.

FIG. 2 is a block diagram illustrating an exemplary training process according to aspects of the disclosure.

At the block 210, training data are obtained. The training data may also be referred to as demonstration data, expert data and so on which represent the behavior of demonstrators or experts for performing a task such as driving a car. The demonstration data may be in the form of a trajectory, which includes a series of data instances for a series of time steps along the trajectory. For example, a trajectory τ=(s_{0:T}, a_{0:T}), where s_{0:T} denotes (s₀, . . . , S_{T}) representing multiple state instances for T+1 time steps, a_{0:T} denotes (a₀, . . . , a_{T}) representing multiple action instances for T+1 time steps. The training data set may be denoted as [symbol] _{demo}={τ_{E}=(s_{0:T}, a_{0:T})}. where [symbol] _{demo} is the demonstration data set, τ_{E} is the trajectory representing demonstration data of an expert or a demonstrator.

The state sₙ may be defined in multiple dimensions, for example, the dimensions may represent the above exampled types of condition data such as whether, speed, distance, navigation information and so on. The action aₙ may be defined in multiple dimensions, for example, the dimensions may represent the action that would be taken by an expert driver such as braking, steering, parking and so on. It is appreciated that the data of trajectory composed of states and actions are known in the art and the disclosure is not limited thereto. In order to obtain the demonstration data, human drivers may drive the car as shown in FIG. 1 in real world to collect the demonstration data, and human drivers may also manipulate a virtual car in an emulator to collect the demonstration data. It is appreciated that the collection of demonstration data of trajectory composed of states and actions are known in the art and the disclosure is not limited thereto.

At step 220, a NN model may be trained with the demonstration data to imitate the behavior of the expert for performing a task such as the exampled driving task. The NN model may be referred to as a learner, agent, imitator and so on. In an embodiment, a new option-GAIL hierarchical framework may be used to train the agent model. The option-GAIL hierarchical framework will be illustrated hereafter.

A Markov Decision Process (MDP) is a 6-element-tuple ( [symbol] , [symbol] , P_{s,s′}^{a}, Rₛ^{a}, μ₀, γ), where ( [symbol] , [symbol] ) denote the state-action space, for example, the above exampled state data s and action data a of a trajectory belong to the state-action space; P_{s,s′}^{a}=P(sₜ₊₁=s′|Sₜ=s, aₜ=a) is the transition probability of next state s′ϵ [symbol] given current state sϵ [symbol] and action aϵ [symbol] , determined by the environment; Rₛ^{a}= [symbol] [rₜ|sₜ=s, aₜ=a] returns the expected reward from the task when taking action a on state s; μ₀(s) denotes the initial state distribution and γϵ[0,1) is a discounting factor. The effectiveness of a policy π(a|s) is evaluated by its expected infinite-horizon reward:

$$η ( π ) = {𝔼}_{{s}_{0} ∼ {μ}_{0} , {a}_{t} ∼ π ( {s}_{t} ) , {s}_{t + 1} ∼ {P}_{{s}_{t} , {s}_{t + 1}}^{{a}_{t}}} [ {\sum }_{t = 0}^{∞} {γ}^{t} {r}_{t} ] .$$

Options [symbol] ={1, . . . , K} may be introduced for modeling the policy-switching procedure on a long-term task, where K represents the number of options. In an example, the options may correspond to subtasks or scenarios of a task. For example, for the task of autonomous driving, different scenarios may include express way, city way with high, normal or low traffic, mountain way, rough road, parking, day driving, night driving, conditional weather such as rain, snowing, foggy, etc., or some combination of the above scenarios. An option model is defined as a tuple ϑ=( [symbol] , [symbol] , {IIₒ, πₒ, βₒ}_{oϵ} [symbol] , π_{ϑ}(o|s), P_{s,s′}^{a}, Rₛ^{a}, μ₀, γ), where, [symbol] , [symbol] , P_{s,s′}^{a}, Rₛ^{a}, μ₀, γ are defined as the same as MDP; IIₒ⊆ [symbol] denotes an initial set of states, from which an option can be activated; βₒ(s)=P(b=1|s) is a terminate function which decides whether current option should be terminated or not on a given state s; πₒ(a|s) is the intra-option policy that determines an action on a given state within an option o; a new option is activated in the call-and-return style by an inter-option policy , πϑ(o|s) once the last option or previous option terminates.

Generative adversarial imitation learning (GAIL) (Ho, J. and Ermon, S. Generative adversarial imitation learning. In Proc. Advances in Neural Inf. Process. Syst., 2016.) is an imitation learning method that casts policy learning upon Markov Decision Process (MDP) into an occupancy measurement matching problem. Given expert demonstrations [symbol] _{demo}={τ_{E}=(S_{0:T}, a_{0:T})} on a specified task such as driving a car, imitation learning aims at finding a policy π that can best reproduce the expert's behavior, without the access of the real reward. The GAIL cast the original maximum-entropy inverse reinforcement learning problem into an occupancy measurement matching problem:

$${arg min}_{π} {D}_{f} ( {ρ}_{π} ( s , a ) \vert \vert {ρ}_{{π}_{E}} ( s , a ) ) , \qquad ( 1 )$$

where, D_{f} computes f-Divergence between ρ_{π}(s, a) and ρ₉₀ _{_{E}}(s, a), which are the occupancy measurements of agent and expert respectively. By introducing a generative adversarial structure, GAIL minimizes the discrepancy between the agent and the expert via alternatively optimizing the policy and the estimated discrepancy. To be specific, a discriminator D_{θ}(s, a): [symbol] × [symbol] [symbol] (0,1) parameterized by θ in GAIL is updated to maximize the discrepancy between the expert and the agent and then the policy π is updated to minimize the overall discrepancy along each trajectory explored by the agent. Such optimization process can be cast into:

$${max}_{θ} {min}_{π} {𝔼}_{π} [ log {D}_{θ} ( s , a ) ] + {𝔼}_{{π}_{E}} [ log ( 1 - {D}_{θ} ( s , a ) ) ] ,$$

where [symbol] _{π} denotes the expectation of the agent under its learned policy π, [symbol] _{π}_{_{E}} denotes the expectation of the expert under its expert policy π_{E}. The GAIL mimicking a policy π from an expert is equivalent to matching its occupancy measurement. This equivalence holds when the policy is one-to-one corresponding to its induced occupancy measurement. However the GAIL is not suitable for imitation learning based on long-term demonstrations since it is hard to capture the hierarchy of sub-tasks by MDP.

The above introduced option model ϑ=( [symbol] , [symbol] , {IIₒ, πₒ, βₒ}_{0ϵ} [symbol] , π_{ϑ}(o|s), P_{s,s′}^{a}, Rₛ^{a}, μ₀, γ) may be used for modeling switching procedure on hierarchical subtasks. However, it is inconvenient to directly learn the policy πₒ and π_{ϑ} of this framework due to the difficulty of determining the initial set IIₒ, and break condition βₒ.

In one embodiment, this option model may be converted to a one-step option, which is defined as one-step ϑₒₙₑ₋ₛₜₑₚ=( [symbol] , [symbol] , [symbol] ⁺, π_{H}, π_{L}, P_{s,s′}^{a}, Rₛ^{a}, \tilde{μ}₀, γ), where [symbol] ⁺= [symbol] ∪{#} consists of all options plus a special initial option class satisfying o₋₁≡#, β_{#}(s)≡1. Besides, \tilde{μ}₀(s, o)≐μ₀(s) [symbol] _{o=#}, where ⇒_{x=y} is the indicator function, and it is equal to 1 iff x=y, otherwise 0. Among the above math symbols, “≡” stands for “identically equal to”, “≐” stands for “be defined as”, “iff” stands for “if and only if”. The high-level policy π_{H} and low-level policy π_{L} are defined as:

$${π}_{H} ( o \vert s , {o}^{′} ) ≐ {β}_{{o}^{′}} ( s ) {π}_{𝒪} ( o \vert s ) + ( 1 - {β}_{{o}^{′}} ( s ) ) {o = {o}^{′}}_{} \qquad ( 2 )$$

$${π}_{L} ( a \vert s , o ) ≐ {π}_{o} ( a \vert s )$$

It can be derived that the one-step option model is equivalent to the full option model, that is, ϑₒₙₑ₋ₛₜₑₚ=O, under practical assumptions. That is, each state is switchable: Iₒ= [symbol] , ∀oϵ [symbol] , and each switching is effective: P(oₜ=oₜ₋₁|βₒ_{_{t−1}}(Sₜ₋₁)=1)=0. The symbol “∀” stands for “any”, “ϵ” stands for “belong to”. This assumption asserts that each state is switchable for each option, and once the switching happens, it switches to a different option with probability 1. Such an assumption usually holds in practice without the sacrifice of model expressiveness.

This equivalence is beneficial as the switching behavior can be characterized by only looking at the high-level policy TH and low-level policy TIL without the need to justify the exact beginning/breaking condition of each option. A overall policy \hat{π} may be defined as \tilde{π}≐(π_{H}, π_{L}), and \tilde{Π}={\tilde{π}} denotes a set of policies.

In order to take advantage of the one-step option ϑₒₙₑ₋ₛₜₑₚ and the GAIL, an option-occupancy measurement may be defined as

$${ρ}_{\tilde{π}} ( s , a , o , {o}^{′} ) ≐ {𝔼}_{\tilde{π}} [ {\sum }_{t = 0}^{∞} {γ}^{t} {( {s}_{t} = s , {a}_{t} = a , {o}_{t} = o , {o}_{t - 1} = {o}^{′} )}_{} ] .$$

The measurement ρ_{\tilde{π}}(s, a, o, o′) can be explained as the distribution of the state-action-option tuple generated by the policy \tilde{π} composed of high-level policy part π_{H} and low-level policy part π_{L} on a given \tilde{μ}₀ and P_{s,s′}^{a}. According to the Bellman Flow constraint, one can easily obtain that the option-occupancy measurement ρ_{\tilde{π}}(s, a, o, o′) belongs to a feasible set of affine constraint

$$𝔻 = \{ ρ ( s , a , o , {o}^{′} ) \geq 0 ; {\sum }_{a , o} ρ ( s , a , o , {o}^{′} ) = {\tilde{μ}}_{0} ( s , {o}^{′} ) + γ {\sum }_{{s}^{′} , {a}^{′} , {o}^{″}} {P}_{{s}^{′} , s}^{{a}^{′}} ρ ( {s}^{′} , {a}^{′} , {o}^{′} , {o}^{″} ) \} .$$

In order to train an agent to imitate expert's behavior for performing a task based on long-term demonstrations such as long-term trajectory data, the GAIL is no longer suitable for this scenario since it is hard to capture the hierarchy of sub-tasks by MDP. In an embodiment, the long-term task that can be divided into multiple subtasks may be modeled via the one-step Option upon GAIL, and the policy \tilde{π} is learned by minimizing the discrepancy of the occupancy measurement between expert and agent.

$${min}_{\tilde{π}} {D}_{f} ( {ρ}_{\tilde{π}} ( s , a ) \vert \vert {ρ}_{{\tilde{π}}_{E}} ( s , a ) ) \qquad ( 3 )$$

FIG. 3 illustrates the probabilistic graph of the one-step option model. As shown, the current option o, which is shown as oₜ is determined using the high-level policy part \tilde{π}_{H} based on the previous option o′, which is shown as oₜ₋₁ and the current state s, which is shown as sₜ. The current state s, which is shown as sₜ, is determined based on the state transition probability P_{s,s′}^{a}. The current action a, which is shown as Aₜ, is determined using the low-level policy part ϕ_{L} based on the current option o and the current state s. The group of nodes oₜ₋₁, oₜ, Aₜ, sₜ are used to induce the option-occupancy measurement.

Intuitively, for the hierarchical subtasks, the action determined by the agent depends not only on the current state observed but also on the current option selected. By the definition of the one-step option ϑₒₙₑ₋ₛₜₑₚ, the hierarchical policy \tilde{π} is relevant to the information of current state, current action, last-time option and current option. In an embodiment the option-occupancy measurement is utilized instead of conventional occupancy measurement to depict the discrepancy between expert and agent. Actually, there is a one-to-one correspondence between the set of policies \tilde{Π} and the set of affine constraint [symbol] .

For each ρϵ [symbol] , it is the option-occupancy measurement of the following policy:

$${π}_{H} = \frac{{\sum }_{a} ρ ( s , a , o , {o}^{′} )}{{\sum }_{a , o} ρ ( s , a , o , {o}^{′} )} , \qquad ( 4 )$$

$${π}_{L} = \frac{{\sum }_{{o}^{′}} ρ ( s , a , o , {o}^{′} )}{{\sum }_{a , {o}^{′}} ρ ( s , a , o , {o}^{′} )}$$

and \tilde{π}=(π_{H}, π_{L}) is the only policy whose option-occupancy measure is ρ.

With the above observation, optimizing the option policy is equivalent to optimizing its induced option-occupancy measurement, since ρ_{\tilde{π}}(s, a, o, o′)=ρ_{\tilde{π}}_{_{E}}(s, a, o, o′)⇔\tilde{π}=\tilde{π}_{E}. Then the hierarchical imitation learning problem becomes:

$${min}_{\overline{π}} {D}_{f} ( {ρ}_{\tilde{π}} ( s , a , o , {o}^{′} ) \vert \vert {ρ}_{{\tilde{π}}_{E}} ( s , a , o , {o}^{′} ) ) \qquad ( 5 )$$

Note that the optimization problem defined on Equation (5) implies the optimization problem defined on Equation (3), but not vice verse: first, since ρ\tilde{π}(s, a)=Σ_{o,o′}ρ_{\tilde{π}}(s, a, o, o′), it can derive that ρ\tilde{π}(s, a, o, o′)=π_{\tilde{π}}_{_{E}} (s, a, o, o′)⇒ρ\tilde{π}(s, a)=ρ_{\tilde{π}}_{_{E}}(s,a); second, as D_{f}(ρ_{\tilde{π}}(s,a, o, o′)∥ρ_{\tilde{π}}_{_{E}}(s, a, o, o′)≤D_{f}(ρ_{\tilde{π}}(s, a)∥ρ_{\tilde{π}}_{_{E}}(s, a)), addressing the problem defined on Equation 5 is addressing an upper bound of that defined on Equation 3. FIG. 4 depicts the relationship between Equation 5 and Equation 3.

In an embodiment, the expert options are observable and are given in the training data, therefore the option-extended expert demonstrations, which is denoted as [symbol] _{demo}={\tilde{τ}=(S_{0:T}, a_{0:T}, o_{-1:T})} where \tilde{τ}is a trajectory with option data additionally, may be used to train the hierarchical policy \tilde{π}.

Rather than calculating the exact value of the option-occupancy measurement, the discrepancy may be estimated by virtue of adversarial learning. A parametric discriminator is defined as D_{θ}(s, a, o, o′): [symbol] × [symbol] × [symbol] × [symbol] ⁺ [symbol] ⁽0,1). If specifying the f-divergence as Jensen-Shannon divergence, Equation (5) can be converted to a min-max game:

$${min}_{\tilde{π}} {max}_{θ} {𝔼}_{{\tilde{D}}_{demo}} [ log ( 1 - {D}_{θ} ( s , a , o , {o}^{′} ) ) ] + {𝔼}_{\tilde{π}} [ log ( {D}_{θ} ( s , a , o , {o}^{′} ) ) ] \qquad ( 6 )$$

The inner loop of equation (6) is to train D_{θ}(s, a, o, o′) with the expert demonstration [symbol] _{demo} and the samples generated by self-exploration with the learned policy \tilde{π}. It is appreciated that θ denotes the parameters of the discriminator D_{θ}(s, a, o, o′), which is trained by optimizing θ. [symbol] _{\tilde{π}} in equation (6) may also be denoted as [symbol] _{\tilde{D}}_{_{\tilde{π}}}, where \tilde{D}_{\tilde{π}}represents the sampled trajectories {\tilde{Σ}=(S_{0:T}, a_{0:T}, o_{-1:T})} generated with the learned policy \tilde{π}. In the outer loop, a hierarchical reinforcement learning (HRL) method may be used to minimize the discrepancy:

$${\tilde{π}}^{⋆} = {arg min}_{\tilde{π}} {𝔼}_{\tilde{π}} [ c ( s , a , o , {o}^{′} ) ] - λ ℍ ( \tilde{π} ) \qquad ( 7 )$$

where c(s, a, o, o′)=log D_{θ}(s, a, o, o′) and the causal entropy [symbol] (\tilde{π}t)= [symbol] _{\tilde{π}}[−log π_{H}−log π_{L}] is used as a policy regularizer with λϵ[0,1]. The cost function is related to options, which is different from many HRL problems with option agnostic cost/reward (Zhang, S. and Whiteson, S. DAC: The double actor-critic architecture for learning options. In Proc. Advances in Neural Inf. Process. Syst., 2019). In order to deal with the cost function related to options, equation (7) may be optimized using similar idea as the DAC.

Particularly, the option model may be characterized as two-level MDPs. For the high-level MDP, state, action and reward may be defined as

$${s}_{t}^{H} ≐ ( {s}_{t} , {o}_{t - 1} ) ,$$

$${a}_{t}^{H} ≐ {O}_{t}$$

$$and$$

$${R}^{H} ( ( s , {o}^{′} ) , o ) ≐ - {\sum }_{a} {π}_{L} ( {a}_{t} \vert {s}_{t} , {o}_{t} ) c ( {s}_{t} , {a}_{t} , {o}_{t} , {o}_{t - 1} ) .$$

For the low=level MDP, state, action and reward may be defined as

$${s}_{t}^{L} ≐ ( {s}_{t} , {o}_{t} ) ,$$

$${a}_{t}^{L} ≐ {a}_{t}$$

$$and$$

$${R}^{L} ( ( s , o ) , a ) ≐ - {\sum }_{{o}^{′}} c ( s , a , o , {o}^{′} ) {p}_{{π}_{H}} ( {o}^{′} \vert s , o )$$

with the posterior probability

$${p}_{{π}_{H}} ( {o}^{′} \vert s , o ) = {π}_{H} ( o \vert s , {o}^{′} ) \frac{p ( {o}^{′} \vert s )}{p ( o \vert s )} .$$

Other terms including the initial state distributions μ₀^{H} and μ₀^{L}, the state-transition dynamics P^{H} and P^{L} may be defined similar to the DAC. Then, the HRL task on Equation 7 can be separated into two non-hierarchical ones with augmented MDPs: [symbol] ^{H}=(S^{H}, A^{H}, P^{H}, R^{H}, μ₀^{H}, γ) and [symbol] ^{L}=(S^{L}, A^{L}, P^{L}, R^{L}, μ₀^{L}, γ), whose action decisions depend on π_{H} and π_{L}, separately. Such two non-hierarchical problems can be solved alternatively by utilizing typical reinforcement learning methods like PPO (Schulman, J., Wolski, F., Dhariwal, P., Radford, A., and Klimov, O. Proximal policy optimization algorithms. arXiv preprint arXiv: 1707.06347, 2017.).

Referring back to equation (6), by alternating the inner loop and the outer loop, the policy \tilde{π}* that addresses Equation 5 can be derived. In an embodiment, with option-extended expert trajectories [symbol] _{demo}={\tilde{Σ}=(S_{0:T}, a_{0:T}, o_{-1:T})} and initial policy \tilde{π}, the policy optimization such as that shown in equation (6) may be alternatively performed for sufficient iterations so as to train the policy \tilde{π}. With the trained policy, the NN model is expected to be capable of reproducing or imitating the behavior of the expert or demonstrator for performing a task. The following pseudo-code shows an exemplary method for training the agent NN model using the demonstration data.

Method 1: Option-GAIL

```
Training Data: Expert trajectories [symbol]    _{demo} = {\tilde{τ} = (s_{0:T}, a_{0:T}, 0_{-1:T})};
Input: Initial policy \tilde{π}⁰ = (π_{H}⁰, π_{L}⁰)
Output: Learned Policy \tilde{π}*
for n = 0 . . . N do
  S-step: sample trajectories with current updated policy \tilde{π}ⁿ to
  get agent sample trajectories [symbol]    ₛₐₘₚₗₑ = {\tilde{τ} = (s_{0:T}, a_{0:T}, 0_{-1:T})}.
  M-step: Update policy \tilde{π}ⁿ to \tilde{π}ⁿ⁺¹ by equation (6).
end
```

Initial policy \tilde{π}⁰ may be obtained in various way. For example, it may be obtained by using randomly generated values, predefined values, or some pretrained values. The aspect of the disclosure is not limited to the initial policy.

The sample of the trajectories of the agent may be performed in various way. For example, the NN model with the current policy \tilde{π}ⁿ may be used to run the task such as the autonomous driving or the robotic locomotion in an emulator, during which the agent sample trajectories [symbol] ₛₐₘₚₗₑ={\tilde{Σ}=(S_{0:T}, a_{0:T}, o_{-1:7})} may be sampled.

In the above discussed embodiment such as the method 1, the expert options are provided in the training data. However, in practice the expert options are usually not available in the training data or in the inference process of the trained agent. In order to address this potential issue, in an embodiment, the options are inferred from the observed data (states and actions).

Given a policy, the options are supposed to be the ones that maximize the likelihood of the observed state-actions, according to the principle of Maximum-Likelihood-Estimation (MLE). In the embodiment, the expert policy may be approximated with the policy i currently learned by the agent NN model through the method described above. With states and actions observed, the option model will degenerate to a Hidden-Markov-Model (HMM), therefore for example a maximum forward message method (Viterbi, A. Error bounds for convolutional codes and an asymptotically optimum decoding algorithm. IEEE transactions on Information Theory, 13(2):260-269, 1967.) may be used for expert option inference.

The most probable values of o_{-1:7} are generated given (π_{H}, π_{L}) and t=(S_{0:T},a_{0:T})ϵ [symbol] _{demo}. Specifically, the maximum forward message is recursively calculated by:

$${\hat{α}}_{t} ( {o}_{t} ) = {max}_{{o}_{o : t - 1}} log P ( {a}_{0 : t} , {o}_{t} \vert {s}_{0 : t} , {o}_{0 : t - 1} , {o}_{- 1} = \# ) = {max}_{{o}_{t - 1}} {\hat{α}}_{t - 1} ( {o}_{t - 1} ) + log {π}_{H} ( {o}_{t} \vert {s}_{t} , {o}_{t - 1} ) + log {π}_{L} ( {a}_{t} \vert {s}_{t} , {o}_{t} ) \qquad ( 8 )$$

$${\hat{α}}_{0} ( {o}_{0} ) = log {π}_{L} ( {a}_{0} \vert {s}_{0} , {o}_{0} ) + log {π}_{H} ( {o}_{0} \vert {s}_{0} , \# ) \qquad ( 9 )$$

It is shown below that deriving the maximum forward message on Equation 8 is able to maximize the probability of the whole trajectory:

$${arg max}_{{o}_{- 1 : T}} P ( {s}_{0 : T} , {a}_{0 : T} , {o}_{- 1 : T} ) ∝ {arg max}_{{o}_{0 : T}} log P ( {a}_{0 : T} , {o}_{0 : T} \vert {s}_{0 : T} , {o}_{- 1} = \# ) = {arg max}_{{o}_{T}} {\hat{α}}_{T} ( {o}_{T} ) . \qquad ( 10 )$$

By back-tracing oₜ₋₁ that induces the maximization on âₜ(oₜ) at each time step of the T-step trajectory, the option-extended expert trajectories [symbol] _{demo}={\tilde{Σ}=(S_{0:T},a_{0:T}, o_{-1:7})} can finally be obtained.

In an embodiment, with expert-provided demonstrations [symbol] _{demo}={\tilde{Σ}_{E}=(S_{0:T}, a_{0:T})} and initial policy \tilde{π}, the policy optimization such as that shown in equation (6) and option inference such as that shown in equation (8) may be alternatively performed for sufficient iterations so as to train the policy \tilde{π}. With the trained policy, the NN model is expected to be capable of reproducing or imitating the behavior of the expert or demonstrator for performing a task. The following pseudo-code 2 shows an exampled method for training the agent NN model using the demonstration data.

Method 2: Option-GAIL

```
Training Data: Expert trajectories [symbol]    _{demo} = {τ_{E} = (s_{0:T}, a0:T)}
Input: Initial policy \tilde{π}⁰ = (π_{H}⁰, π_{L}⁰)
Output: Learned Policy \tilde{π}*
for n = 0 . . . N do
  E-step: Infer expert options with current updated policy \tilde{π}ⁿ
  by equation (8) and get option-extended expert trajectories [symbol]
  _{demo} = {\tilde{τ} = (s_{0:T}, a_{0:T}, 0_{-1:T})}; sample trajectories
  with current updated policy \tilde{π}ⁿ to get agent sample
  trajectories [symbol]    ₛₐₘₚₗₑ = {\tilde{τ} = (s_{0:T}, a_{0:T}, 0_{-1:T})}.
  M-step: Update policy \tilde{π}ⁿ to \tilde{π}ⁿ⁺¹ by equation (6).
end
```

The method 2 may be referred to as Expectation-Maximization (EM)-style process: an E-step that samples the options of expert conditioned on the current learned policy, and an M-step that updates the low- and high-level policies of agent simultaneously to minimize the option-occupancy measurement between expert and agent.

FIG. 5 is a block diagram illustrating an exemplary training process for training a NN model for imitating demonstrator's behavior based on demonstration data according to aspects of the disclosure.

At 510, demonstration data representing the demonstrator's behavior for performing a task are obtained. The demonstration data includes state data, action data and option data. The state data correspond to a state for performing the task, the term state may also be referred to as condition, circumstance, context, status or the like. The option data correspond to subtasks of the task, the subtasks may correspond to respective scenarios related to the task. The action data correspond to the demonstrator's actions performed for the task. In an embodiment, the option-extended expert trajectories [symbol] _{demo}={\tilde{Σ}=(S_{0:T}, a_{0:T}, o_{-1:T})} are example of the demonstration data, where \tilde{Σ} represents a trajectory, S_{0:T} represents respective state instances along the trajectory, a_{0:T} represents respective action instances along the trajectory, o_{-1:T} represents respective option instances along the trajectory, T representing the number of time steps along the trajectory.

At 520, learner data representing the NN model's behavior for performing the task are sampled based on a current learned policy. The learner data includes state data, action data and option data. The state data correspond to a state for performing the task, the term state may also be referred to as condition, circumstance, context, status or the like. The option data correspond to subtasks of the task, the subtasks may correspond to respective scenarios related to the task. The action data correspond to the leaner's actions performed for the task. In an embodiment, the sampled learner trajectories [symbol] ₛₐₘₚₗₑ={\tilde{Σ}=(S_{0:T}, a_{0:T}, o_{-1:7})} are example of the sampled learner data, where \tilde{Σ}represents a trajectory, So: represents respective state instances along the trajectory, a_{0:T} represents respective action instances along the trajectory, o_{-1:T} represents respective option instances along the trajectory, T representing the number of time steps along the trajectory. The policy consists of a high level policy part for determining a current option and a low level policy part for determining a current action. In an embodiment, the high level policy part is configured to determine the current option based on a current state and a previous option, and the low level policy part is configured to determine the current action based on the current state and the current option. In an embodiment, each of the high level policy part and the low level policy part is a function of a state, an action, an option and a previous option.

At 530, the policy of the NN model is updated by using a generative adversarial imitation learning (GAIL) process based on the demonstration data and the learner data.

FIG. 6 is a block diagram illustrating an exemplary process for obtaining demonstration data at 510 of FIG. 5 according to aspects of the disclosure.

At 5110, initial demonstration data including the state data and the action data without the option data are obtained. In an embodiment, the expert trajectories [symbol] _{demo}={\tilde{Σ}_{E}=(S_{0:T}, a_{0:T})} may be example of the initial demonstration data.

At 5120, the option data is estimated or inferred by using the current learned policy based on the state data and the action data included in the initial demonstration data.

At 5130, the demonstration data are obtained by supplementing the estimated or inferred option data into the initial demonstration data.

In an embodiment, the inferring the option data at 5120 may comprise: generating the most probable values of the option data by using a Maximum-Likelihood-Estimation process based on the current learned policy as well as the state data and the action data included in the initial demonstration data. In an embodiment, equation (8) is an example of the Maximum-Likelihood-Estimation process for estimating the most probable values of the option data.

FIG. 7 is a block diagram illustrating an exemplary process for updating the policy at 530 of FIG. 5 according to aspects of the disclosure.

At 5310, discrepancy between the demonstrator's behavior and the NN model's behavior is estimated based on the demonstration data and the learner data by using a discriminator. In an embodiment, discrepancy of occupancy measurement between the demonstration data and the learner data is estimated by using the discriminator, wherein the occupancy measurement is a function of a state, an action, an option and a previous option. In an embodiment, each of the high level policy part and the low level policy part is a function of the occupancy measurement.

At 5320, parameters of the discriminator are updated with a target of maximizing the discrepancy in an inner loop.

At 5330, parameters of the current learned policy are updated with a target of minimizing discrepancy in an outer loop. In an embodiment, the parameters of the current learned policy are updated by using a hierarchical reinforcement learning (HRL) process characterized as two-level MDPs. In an embodiment, a policy regularizer used in the HRL process is a function of the high level policy part and the low level policy part.

In an aspect of the disclosure, a method for training a Neural Network (NN) model for self-driving assistance is proposed. The NN model for self-driving assistance is trained using the method of any embodiment described herein, such as the embodiments described with reference to FIGS. 2-7, where the demonstration data represents a driver's behavior for driving a vehicle. The self-driving assistance may also be referred to as autonomous driving, intelligent driving, AI driving or the like.

In an aspect of the disclosure, a method for training a Neural Network (NN) model for controlling robot locomotion is proposed. The NN model for controlling robot locomotion is trained using the method of any embodiment described herein, such as the embodiments described with reference to FIGS. 2-7, where the demonstration data represents a demonstrator's locomotion for performing a task. The robot locomotion may include various kinds of robotic locomotion, such as, robot walking, jumping, robot finding a way across barriers, mechanical arms performing a task like human, or the like.

FIG. 8 is a block diagram illustrating an exemplary process for controlling a machine with a trained Neural Network (NN) model according to aspects of the disclosure.

At 810, environment data related to performing a task by the machine are collected. For example, the sensors 110 as illustrated in FIG. 1 may be used to collect the environment data.

At 820, state data and option data for the current time instant are obtained based at least in part on the environment data. In an embodiment, state data for the current time instant may be obtained from the environment data, and the option data may be inferred for the current time based on the state data. For example, the option data may be inferred for the current time based on the state data and the option data at the last time step.

At 830, action data for the current time instant is inferred based on the state data and the option data for the current time instant with the trained NN model; and

At 840, action of the machine is controlled based on the action data for the current time.

In an aspect of the disclosure, a vehicle capable of self-driving assistance is provided. For example, as illustrated in FIG. 1, the vehicle comprises sensors configured for collecting at least a part of environment data related to performing self-driving assistance by the vehicle; one or more processors; and one or more storage devices storing computer-executable instructions that, when executed, cause the one or more processors to perform the operations of the method of the embodiments described in the disclosure.

In an aspect of the disclosure, a robot capable of automatic locomotion is provided. For example, as illustrated in FIG. 1 which may also represent the structure of the robot, the robot comprises sensors configured for collecting at least a part of environment data related to performing automatic locomotion by the robot; one or more processors; and one or more storage devices storing computer-executable instructions that, when executed, cause the one or more processors to perform the operations of the method of the embodiments described in the disclosure.

FIG. 9 illustrates an exemplary computing system according to an embodiment. The computing system 900 may comprise at least one processor 910. The computing system 900 may further comprise at least one storage device 920. The storage device 920 may store computer-executable instructions that, when executed, cause the processor 910 to perform any operations according to the embodiments of the present disclosure as described in connection with FIGS. 1-8.

The embodiments of the present disclosure may be embodied in a computer-readable medium such as non-transitory computer-readable medium. The non-transitory computer-readable medium may comprise instructions that, when executed, cause one or more processors to perform any operations according to the embodiments of the present disclosure as described in connection with FIGS. 1-8.

The embodiments of the present disclosure may be embodied in a computer program product comprising computer-executable instructions that, when executed, cause one or more processors to perform any operations according to the embodiments of the present disclosure as described in connection with FIGS. 1-8.

It should be appreciated that all the operations in the methods described above are merely exemplary, and the present disclosure is not limited to any operations in the methods or sequence orders of these operations, and should cover all other equivalents under the same or similar concepts.

It should also be appreciated that all the modules in the apparatuses described above may be implemented in various approaches. These modules may be implemented as hardware, software, or a combination thereof. Moreover, any of these modules may be further functionally divided into sub-modules or combined together.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skill in the art are expressly incorporated herein by reference and are intended to be encompassed by the claims.

1-20. (canceled)

21. A method for training a Neural Network (NN) model for imitating behavior of a demonstrator, comprising the following steps:
obtaining demonstration data representing a behavior of the demonstrator for performing a task, the demonstration data includes state data, action data and option data, wherein the state data of the demonstration data correspond to a condition for performing the task, the option data of the demonstration data correspond to subtasks of the task, and the action data of the demonstration data correspond to actions of the demonstrator performed for the task;
sampling learner data representing a behavior of the NN model for performing the task based on a current learned policy, the learner data includes state data, action data and option data, wherein the state data of the learner data correspond to a condition for performing the task, the option data of the learner data correspond to subtasks of the task, and the action data of the learner data correspond to actions of NN model performed for the task, the policy includes a high level policy part for determining a current option and a low level policy part for determining a current action; and
updating the policy by using a generative adversarial imitation learning (GAIL) process based on the demonstration data and the learner data.

22. The method of claim 21, wherein the high level policy part is configured to determine a current option based on a current state and a previous option, and the low level policy part is configured to determine a current action based on the current state and the current option.

23. The method of claim 22, wherein each of the high level policy part and the low level policy part is a function of a state, an action, an option and a previous option.

24. The method of claim 21, wherein the demonstration data include trajectories represented as [symbol] demo={\tilde{τ}=(S_{0:T}, a_{0:T}, o_{-1:7}) }, where [symbol] demo representing the demonstration data, Σ representing a trajectory, s_{0:T} representing respective state instances along the trajectory, a_{0:T} representing respective action instances along the trajectory, o_{-1:T} representing respective sampled option instances along the trajectory, T representing a number of time steps along the trajectory, and wherein the learner data include trajectories represented as [symbol] ₛₐₘₚₗₑ={\tilde{τ}=(S_{0:T}, a_{0:T}, o_{-1:7})}, where [symbol] sample representing the demonstration data, \tilde{τ} represents a trajectory, s_{0:T} represents respective state instances along the trajectory, a_{0:T} represents respective action instances along the trajectory, o_{-1:7} represents respective option instances along the trajectory, T representing a number of time steps along the trajectory.

25. The method of claim 21, wherein the obtaining of the demonstration data includes:
obtaining initial demonstration data including the state data and the action data without the option data;
inferring the option data by using a current learned policy based on the initial demonstration data; and
obtaining the demonstration data by supplementing the inferred option data into the initial demonstration data.

26. The method of claim 25, wherein the inferring of the option data includes:
generating most probable values of the option data by using a Maximum-Likelihood-Estimation process based on the current learned policy and the state data and the action data included in the initial demonstration data.

27. The method of claim 21, wherein the updating of the policy includes:
estimating a discrepancy between the behavior of the demonstrator and the behavior or the NN model based on the demonstration data and the learner data by using a discriminator;
updating parameters of the discriminator with a target of maximizing the discrepancy in an inner loop; and
updating parameters of a current learned policy with a target of minimizing the discrepancy in an outer loop.

28. The method of claim 27, wherein the estimating of the discrepancy includes:
estimating a discrepancy of an occupancy measurement between the demonstration data and the learner data by using the discriminator, wherein the occupancy measurement is a function of a state, an action, an option, and a previous option.

29. The method of claim 28, wherein each of the high level policy part and the low level policy part is a function of the occupancy measurement.

30. The method of claim 27, wherein the updating of the parameters of the current learned policy includes:
updating the parameters of the current learned policy by using a hierarchical reinforcement learning (HRL) process characterized as two-level Markov Decision Process (MDP).

31. The method of claim 30, wherein a policy regularizer used in the HRL process is a function of the high level policy part and the low level policy part.

32. A method for training a Neural Network (NN) model for self-driving assistance, comprising the following steps:
training the NN model for self-driving assistance by:
obtaining demonstration data representing a behavior of a demonstrator for performing a task, the demonstration data includes state data, action data and option data, wherein the state data of the demonstration data correspond to a condition for performing the task, the option data of the demonstration data correspond to subtasks of the task, and the action data of the demonstration data correspond to actions of the demonstrator performed for the task,
sampling learner data representing a behavior of the NN model for performing the task based on a current learned policy, the learner data includes state data, action data and option data, wherein the state data of the learner data correspond to a condition for performing the task, the option data of the learner data correspond to subtasks of the task, and the action data of the learner data correspond to actions of NN model performed for the task, the policy includes a high level policy part for determining a current option and a low level policy part for determining a current action, and
updating the policy by using a generative adversarial imitation learning (GAIL) process based on the demonstration data and the learner data;
wherein the demonstration data represents a driver's behavior for driving a vehicle.

33. A method for training a Neural Network (NN) model for controlling robot locomotion, comprising:
training the NN model for controlling robot locomotion by:
obtaining demonstration data representing a behavior of a demonstrator for performing a task, the demonstration data includes state data, action data and option data, wherein the state data of the demonstration data correspond to a condition for performing the task, the option data of the demonstration data correspond to subtasks of the task, and the action data of the demonstration data correspond to actions of the demonstrator performed for the task,
sampling learner data representing a behavior of the NN model for performing the task based on a current learned policy, the learner data includes state data, action data and option data, wherein the state data of the learner data correspond to a condition for performing the task, the option data of the learner data correspond to subtasks of the task, and the action data of the learner data correspond to actions of NN model performed for the task, the policy includes a high level policy part for determining a current option and a low level policy part for determining a current action, and
updating the policy by using a generative adversarial imitation learning (GAIL) process based on the demonstration data and the learner data;
wherein the demonstration data represents a demonstrator's locomotion for performing a task.

34. A method for controlling a machine with a trained Neural Network (NN) model, comprising the following steps:
collecting environment data related to performing a task by the machine;
obtaining state data and option data for a current time instant based at least in part on the environment data;
inferring action data for the current time instant based on the state data and the option data for the current time instant with the trained NN model; and
controlling an action of the machine based on the action data for the current time.

35. The method of claim 34, wherein the obtaining of the state data and the option data includes:
obtaining state data for the current time instant based at least in part on the environment data; and
inferring the option data for the current time based at least in part on the state data.

36. A vehicle capable of self-driving assistance, comprising:
sensors configured to collect at least a part of environment data related to performing self-driving assistance by the vehicle;
one or more processors; and
one or more non-transitory storage devices storing computer-executable instructions that, when executed by the one or more processors, cause the one or more processors to perform the following steps:
collecting environment data related to performing a task by the vehicle,
obtaining state data and option data for a current time instant based at least in part on the environment data,
inferring action data for the current time instant based on the state data and the option data for the current time instant with the trained NN model, and
controlling an action of the vehicle based on the action data for the current time.

37. A robot capable of automatic locomotion, comprising:
sensors configured to collect at least a part of environment data related to performing automatic locomotion by the robot;
one or more processors; and
one or more non-transitory storage devices storing computer-executable instructions that, when executed by the one or more processors, cause the one or more processors to perform the following steps:
collecting environment data related to performing a task by the robot,
obtaining state data and option data for a current time instant based at least in part on the environment data,
inferring action data for the current time instant based on the state data and the option data for the current time instant with the trained NN model, and
controlling an action of the robot based on the action data for the current time.

38. A computer system, comprising:
one or more processors; and
one or more non-transitory storage devices storing computer-executable instructions for training a Neural Network (NN) model for imitating behavior of a demonstrator, the instructions, when executed by the one or more processors, cause the one or more processors to perform:
obtaining demonstration data representing a behavior of the demonstrator for performing a task, the demonstration data includes state data, action data and option data, wherein the state data of the demonstration data correspond to a condition for performing the task, the option data of the demonstration data correspond to subtasks of the task, and the action data of the demonstration data correspond to actions of the demonstrator performed for the task,
sampling learner data representing a behavior of the NN model for performing the task based on a current learned policy, the learner data includes state data, action data and option data, wherein the state data of the learner data correspond to a condition for performing the task, the option data of the learner data correspond to subtasks of the task, and the action data of the learner data correspond to actions of NN model performed for the task, the policy includes a high level policy part for determining a current option and a low level policy part for determining a current action, and
updating the policy by using a generative adversarial imitation learning (GAIL) process based on the demonstration data and the learner data.

39. One or more non-transitory computer readable storage media on which are stored computer-executable instructions for training a Neural Network (NN) model for imitating behavior of a demonstrator, the computer-executable instructions, when executed by one or more processors, cause the one or more processor to perform the following steps:
obtaining demonstration data representing a behavior of the demonstrator for performing a task, the demonstration data includes state data, action data and option data, wherein the state data of the demonstration data correspond to a condition for performing the task, the option data of the demonstration data correspond to subtasks of the task, and the action data of the demonstration data correspond to actions of the demonstrator performed for the task;
sampling learner data representing a behavior of the NN model for performing the task based on a current learned policy, the learner data includes state data, action data and option data, wherein the state data of the learner data correspond to a condition for performing the task, the option data of the learner data correspond to subtasks of the task, and the action data of the learner data correspond to actions of NN model performed for the task, the policy includes a high level policy part for determining a current option and a low level policy part for determining a current action; and
updating the policy by using a generative adversarial imitation learning (GAIL) process based on the demonstration data and the learner data.
